(19) United States
(12) Patent Application Publication
(10) Pub. No.: US 2010/0171696 A1
(43) Pub. Date: Jul. 8, 2010

(54) MOTION ACTUATION SYSTEM AND RELATED MOTION DATABASE

(76) Inventor: Chi Kong Wu, Hong Kong (HK)

Correspondence Address: MICHAEL BEST & FRIEDRICH LLP, 100 E WISCONSIN AVENUE, Suite 3300, MILWAUKEE, WI, 53202, US

(21) Appl. No.: 12/349,247

(22) Filed: Jan. 6, 2009

(51) Int. Cl. G09G 5/08; G06F 3/033

(52) U.S. Cl. 345/158; 715/863

(57) ABSTRACT

The claimed invention relates to an interactive system for recognizing a single or a series of hand motion of the user to control or create applications used in multimedia. In particular, the system includes a motion sensor detection unit (MSDU) 100 and a motion sensor interface (MSI) 110. More specifically, the motion sensor detection unit (MSDU) 100 additionally includes one or more controllers 102; the motion interface (MSI) 110 additionally includes a MEMS signal processor (MSP) 120, a motion interpreter and translator (MIT) 140, an Embedded UI Toolkits 150 and applications subunit 160. The claimed invention also relates to a motion database 130 which stores the motion event pre-defined by the user or manufacturer. The motion database 130 also allows the user to define the motion database according to the user's preference.

### TECHNICAL FIELD

The claimed invention relates to an interactive system incorporated with a motion database for sensing and recognizing the user's motion in order for the user to remotely control a number of multimedia applications such as TV, electronic program guide, home media center, web browsing and photo editing.

### SUMMARY OF INVENTION

Multimedia systems enable the user to control a variety of applications in a single system. A user-friendly media control system is therefore on demand in the multimedia industry to facilitate the development of multifunctional user interface, especially for users who may have physical limitations. Although there are a number of existing user interface controlling systems which rely on sensing the gesture or motions of the user, they either encounter the problem of sensitivity of the signals from the signal sensor or the complexity of the user interface. For example, some systems only incorporate an optical sensor to receive image signals from the user. The problems of these systems include the low sensitivity of the image signals and the limitation to the distance between the user and the optical sensor. Other existing systems may require an actual contact between the user and the user interface such as a touch screen in order to perform certain action other than simple hand gesture or motions. These systems are usually pre-installed with complicated instructions for user to follow which are not in favor of the user's preference.

As compared to conventional system, the claimed invention has the following advantages, but not limited to: (a) No touch interface is required; (b) Fewer buttons is required on the controller; (c) More than a pointing device; (d) No line of sight restriction; (e) Better user experience with inherent motion; and (f) Enable faster selection and information search.

In the first aspect of the claimed invention, it relates to a system including a motion sensor detection unit (MSDU) and a motion sensor interface (MSI). The MSDU according to the claimed invention includes a physical controller in any shape with one or more buttons for creating motion signals by the user and sending the same virtually to the wireless receiver at the other end of the system. The MSI according to the claimed invention includes four subunits: (i) MEMS Signal Processor (MSP); (ii) Motion Interpreter and Translator (MIT); (iii) Embedded UI Toolkit; and (iv) Applications Subunit. The MSP according to the claimed invention additionally includes a wireless receiver which receives motion signals from one or more of the corresponding controller(s). The MSP according to the claimed invention further includes a motion data compensator, a motion filter and a motion recognizer which are responsible for removing positioning errors, filtering noise background of the digital signals and determining the motion signals from the motion database respectively. The MIT according to the claimed invention is responsible for interpreting the best matched motion from the output of MSP and sending the corresponding event to applications subunit. The MIT according to the claimed invention additionally includes a logic device for characterizing whether the event is directed to a browser application or a non-browser application. The Embedded UI Toolkit according to the claimed invention can receive the application events from MIT and visualize the motion feedback according to the program logic in applications subunit. The applications subunit according to the claimed invention includes a software program to execute the command of the browser or non-browser application event which is characterized by the MIT. Different type of application event is either directed to a browser application layer or a non-browser application layer of the applications subunit. The applications subunit according to the claimed invention can implement different applications including but not limited to: general TV operation, electronic program guide (EPG), home media center (HMC), web browsing, photo editing.

In the second aspect of the claimed invention, it relates to methods of using an interactive system incorporated with a motion database which is for storing the data of the user's motion and matching the single or a series of motion signals received from the motion sensor detection unit (MSDU) with the stored data in the database. Mapped data in motion database creates a motion event for further translation in the motion interpreter and translator according to the claimed invention. User can pre-define a single or a series of motions including tilting the controller in any of the three axes about the controller a three-dimensional manner and/or pressing or chording one or more keys on the controller in order to create a motion data for controlling certain function in the application on the motion sensor interface according to the claimed invention. Such data is stored in the motion database as a pre-defined data for later mapping purpose. User can also define the motion database and control the applications simultaneously. The motion database according to the claimed invention can also store the motion feedback from the application subunits as user's experience data.

### BRIEF DESCRIPTION OF FIGURES

FIG. 1 is the flow diagram of the system according to the claimed invention.

FIG. 2 is side view of the three-dimensional movements of the controller by the user according to the claimed invention and the display for showing the user interface.

FIGS. 3a-3g are front view of a graphical interface showing how different motion signals listed in table 2 control different functions in TV application.

FIGS. 4a-4j are front view of a graphical interface showing how different motion signals listed in table 3 control different functions in Electronic Program Guide (EPG)

FIGS. 5a and 5b are front view of a graphical interface showing how different motion signals listed in table 4 control different functions in Home Media Center (HMC).

FIGS. 6a-6d are front view of a graphical interface showing how different motion signals listed in table 5 control different functions in Web browsing.

FIGS. 7a-7c are front view of a graphical interface showing how different motion signals listed in table 6 control different functions in photo editing.

### DETAILED DESCRIPTION OF INVENTION

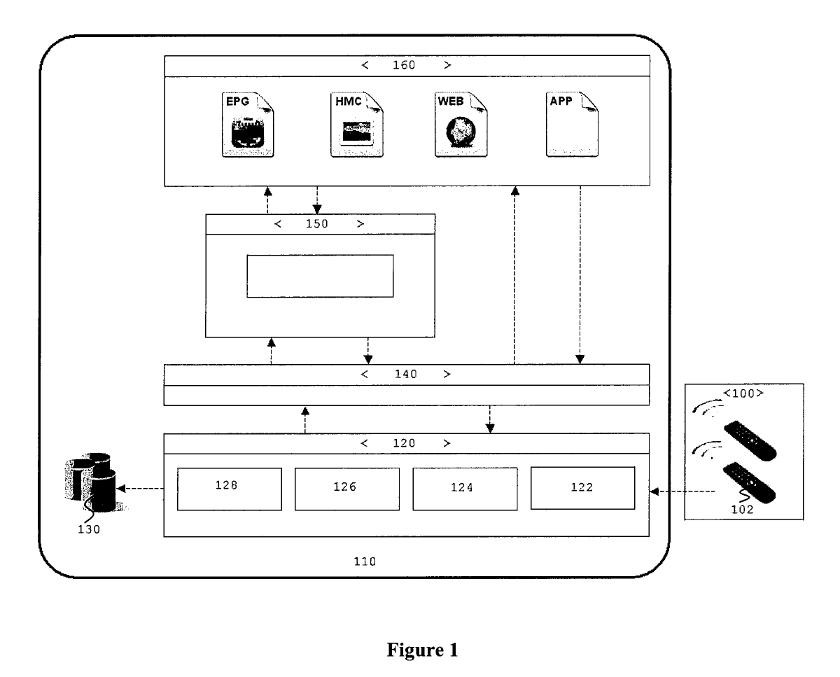

FIG. 1 illustrates the units and subunits of the system according to the claimed invention and the interactions among the units and the interactions among the subunits of the system. The system according to FIG. 1 includes a motion sensor detection unit 100 and a motion sensor interface 110. The motion sensor detection unit may include one or more controller(s) 102. One or more users can use the motion sensor detection unit at the same time by using one or more controller(s). In one embodiment, the controller includes one or more button(s) (not shown in FIG. 1). A user may press on one or more button(s) of the controller (not shown in FIG. 1), or he/she may chord one or more button(s) of the controller (not shown in FIG. 1), or he/she may press at least one button and chord at least one another button at the same time. In another embodiment, the controller includes no button. The controller according to the claimed invention can be in any shape. According to FIG. 1, the signal transmitted from the controller 102 of the MSDU 100 to the MSP 120 can be signals in any modes of frequencies, for example, ZigBee, Bluetooth Lower Energy, IR, or Z-wave or any signals that can be received by the wireless receiver 122 of the MSP 120. In one embodiment, the signals can be transmitted from one terminal of the controller. In another embodiment, the signals can be transmitted from any terminals of the controller. The controller 102 according to FIG. 1 is powered by battery. The battery is rechargeable or replaceable.

The MSP 110 according to FIG. 1 includes four subunits: (i) MEMS signal processor (MSP) 120; (ii) Motion interpreter and Translator (MIT) 140; (iii) Embedded UI Toolkit 150; and (iv) Applications Subunit 160. The MSP according to FIG. 1 additionally includes a motion database 130 for storing the motion data which is either pre-defined by the user or manufacturer or defined at the time of using the system. In MSP 110 according to FIG. 1, the receiver of signals from the controller 102 of the MSDU 100 is a wireless receiver 122. The wireless receiver according to the claimed invention is configured to receive any frequencies of signals transmitted from the MSDU. In one embodiment, the wireless receiver is configured to receive signals transmitted from MSDU in the frequency of a ZigBee mode. In another embodiment, the wireless receiver is configured to receive signals transmitted from MSDU in the frequency of a Bluetooth's ULP mode. In other embodiment, the wireless receiver is configured to receive signals transmitted from MSDU in the frequency of a ZigBee mode or any signal transmission modes in the field of wireless technologies. If the frequency of the signal transmitted from the controller is in IR mode, the wireless receiver according to the claimed invention requires multiple IR receivers (not shown in FIG. 1) to support more than one controller which transmit signals in IR mode.

In MSP 120 according to FIG. 1, the motion compensator 124 is an intermediate module to remove the positioning errors with respect to the motion signals emitted from the controller of the MSDU. In MSP 120 according to FIG. 1, the motion filter 126 is also an intermediate module to avoid noise generated from the MSDU 100. After going through the processing of motion signals by the motion compensator 124 and the motion filter 126, the processed motion signals is either matched with the pre-defined motion signals stored in the motion recognizer 128 or is stored in the same motion database 130. In one embodiment, the motion database stores a set of data recording a single or a series of pre-defined motions by the user or by the manufacturer before using the system. In another embodiment, the system according to the claimed invention enables the user to define a single or a series of motions as a specific event and store it in the motion database at the time of using the system. In other embodiment, the user can define a single or a series of motions as a specific event and such defined event can be further processed in MSI of the system.

After the mapping of the motion signals by the motion recognizer 128 according to FIG. 1, the mapped event(s) are sent to MIT 140 for translation and/or interpretation. MIT 140 is configured to interpret the best matched motion event from the output motion event of MSP 120 and to distinguish whether such output motion event is a browser or non-browser application. In one embodiment, MIT sends the motion event to the applications subunit directly if such motion event can be mapped with any application event being configured in the MIT. The mapped motion event is then translated into corresponding application event and the translated event is further sent to the non-browser application layer (not shown in FIG. 1) of the applications subunit 160 to perform user interface action. The MIT in that embodiment can also receive motion feedback directly from the non-browser application layer (not shown in FIG. 1) of the applications subunit 160 to store the motion feedback as a user experience data.

The unmapped motion event is sent to the browser application layer and the non-browser application layer. An application in either application layer gets a matching list by comparing the unmapped motion with the pre-defined motion signals stored in the motion recognizer 128 or stored in the same motion database 130 or by obtaining the matching list from earlier comparison during the mapping of the motion signals by the motion recognizer 128. The matching list contains matching values between the unmapped motion and each of pre-defined motion signals. The application has the logic to handle the unmapped motion event. In one embodiment, the application enables the user to select the motion or instruction he intends to generate from the matching list based on the matching values. In another embodiment, the application shows an error message as the motion signals cannot be recognized. In other embodiment, the application simply ignores the unmapped motion event.

The Embedded UI Toolkit 150 according to FIG. 1 is configured to receive events from MIT and visualizes the motion feedback according to the program logic in the application subunit 160. The Embedded UI Toolkit is also configured to enable better user experience with inherent motion control to harmonize with the Graphical User Interface. In one embodiment, Embedded UI Toolkit can send the motion event from MIT to the browser application layer of the applications subunit. In another embodiment, Embedded UI Toolkit may also receive motion feedback from the browser application layer of the applications subunit to MIT. Such motion feedback from the browser application layer of the application subunits to MIT reflects the action after the processing of input data by the program logic in the application subunit. In addition, the non-browser application layer of the application subunits can also give the motion feedback to MIT without going through the Embedded UI Toolkit.

As a result, the interactions at the unit level and at the subunit level of the system according to FIG. 1 enable the effective sensing and processing of motion signals into commands for controlling different functions in application by a single or a series of user's hand motion and/or finger motion on the controller.

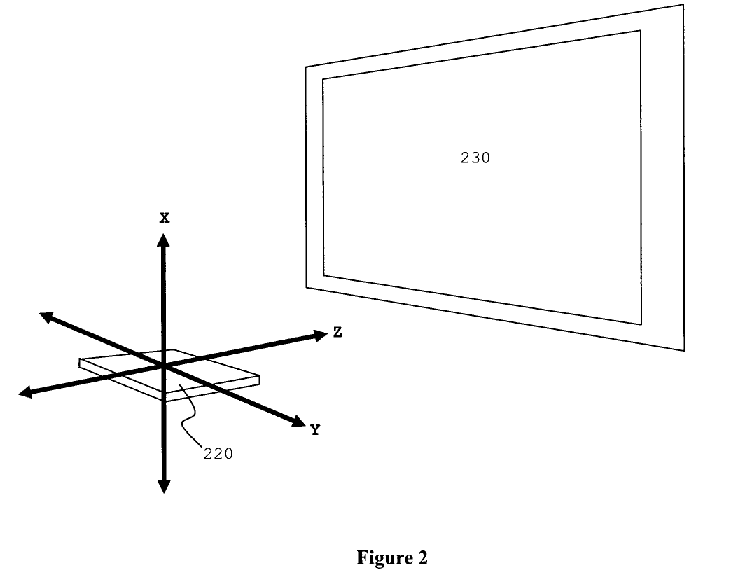

FIG. 2 illustrates the three-dimensional movements of the hand motion of the user. The controller 230 of MSDU according to the claimed invention is configured to sense the hand motion of the user into three axes about the controller 220 including x-axis, y-axis and z-axis. Such three-dimensional resolution of the hand motion enables the user to perform all kinds of hand motion according to the applications displayed on a physical screen 230. Generally, there are three pairs of hand motions along three axes respectively. In one embodiment, the user can tilt left or right using the controller to create motion signals along the x-axis. In another embodiment, the user can tilt up and down using the controller to create motion signals along the y-axis. In other embodiment, the user can tile +z/-z using the controller to create motion signals along the z-axis. The controller according to the claimed invention is configured to enable the sensing of the hand motion of the user together with the finger motions of pressing and/or chording one or more button(s) (not shown in FIG. 2) of the controller, depending on the user's preference and the application. Any of these finger motions can be performed before, during or after the hand motions of the user. Different combinations between hand motion and finger motion allows a user to control a number of functions in an application by simply using the controller according to the claimed invention which has fewer buttons than the conventional system in the state of art. The claimed invention also allows user to define his/her own set of hand and/or finger motions using the controller in order to suit specific need of some user.

The following examples illustrate some of the combination of motion and its corresponding meaning in different application. These examples do not limit the scope of the claimed invention and user can define his/her own motion according to the disclosure of the claimed invention.

### EXAMPLES

Table 1 lists some general user-defined motions and their corresponding meaning(s) for controlling the general user interface as well as some general features shared by different applications in the system.

TABLE 1
Application in General

| | Chord/Key | Chord/Key | | |
|---|---|---|---|---|
| Motion | “1” | “2” | Meaning | Remark |
| Up | | | Upper item/Increase | |
| | | | by 1 | |
| Down | | | Lower item/ | |
| | | | Decrease by 1 | |
| Left | | | Left item/Decrease | |
| | | | by 1 | |
| Right | | | Right item/Increase | |
| | | | by 1 | |
| Tilt Up | | | Upper item/Increase | |
| | | | by 1 | |
| Tilt Down | | | Lower item/ | |
| | | | Decrease by 1 | |
| Tilt Left | | | Left item/Decrease | |
| | | | by 1 | |
| Tilt Right | | | Right item/Increase | |
| | | | by 1 | |
| Tile −Z | | | Left item/Decrease | |
| | | | by 1 | |
| Tile +Z | | | Right item/Increase | |
| | | | by 1 | |
| Press | | | Select/Enter | |
| Key “1” | | | | |
| Press | | | Back/Exit | |
| Key “2” | | | | |
| Chord | | ✓ | Menu | Hold for |
| Key “2” | | | | a period |
| Up | ✓ | | Page Up | |
| Down | ✓ | | Page Down | |
| Left | ✓ | | Backward Page | |
| Right | ✓ | | Forward Page | |
| Tilt Up | ✓ | | Page Up | |
| Tilt Down | ✓ | | Page Down | |
| Tilt Left | ✓ | | Backward Page | |
| Tilt Right | ✓ | | Forward Page | |
| Tile −Z | ✓ | | Backward Page | |
| Tile +Z | ✓ | | Forward Page | |

In table 1, the up and down, and the left and right motions represent the displacement of the controller by the user's hand motion along the x-axis and the y-axis respectively. The tilt up and tilt down, the tilt left and tilt right, and the tile +z and tile −z motions represent the angular movement of the controller by the hand motion of the user about the origin. Each of these hand motions has its specific meaning depending on the nature of application and the user's preference. The additional two buttons (key “1” and key “2”) on the controller allow the user to take additional finger motion by either pressing or chording on one or more of these buttons. Similarly, each of these finger motions can also have its specific meaning depending on the nature of the application and the user's preference. Different combinations of hand motion and finger motion allow the user to create a number of motion signals by the controller according to the claimed invention with the advantage of fewer buttons than those in the state of art.

In Table 2, user can define the motion database for the application in TV according to the motions listed in the table and their corresponding meaning.

TABLE 2
Application in TV

| Motion | Chord/Key “1” | Chord/Key “2” | Meaning | Remark |
|---|---|---|---|---|
| Tilt Up | | | Channel up | The functionalities |
| Tilt Down | | | Channel down | of the pairs Tilt |
| Tilt Left | | | Volume down | up/Tilt down and |
| Tilt Right | | | Volume up | Tilt left/Tilt right is |
| | | | | up to the |
| | | | | application. Tilt |
| | | | | up/Tilt down can be |
| | | | | used for Volume |
| | | | | up/Volume down |
| | | | | instead. |
| Tile −Z | | | Volume down | same as Tilt Left |
| Tile +Z | | | Volume up | same as Tilt Right |
| Press Key “1” | | | Select/Enter | |
| Displacement | ✓ | | Channel shortcut | For example, |
| Motion + | | | | writing ‘12’ will |
| Chord Key “1” | | | | change to channel |
| | | | | 12 |
| Press Key “2” | | | Back/Exit | |
| Chord Key “2” | | ✓ | Menu | Hold for a period |

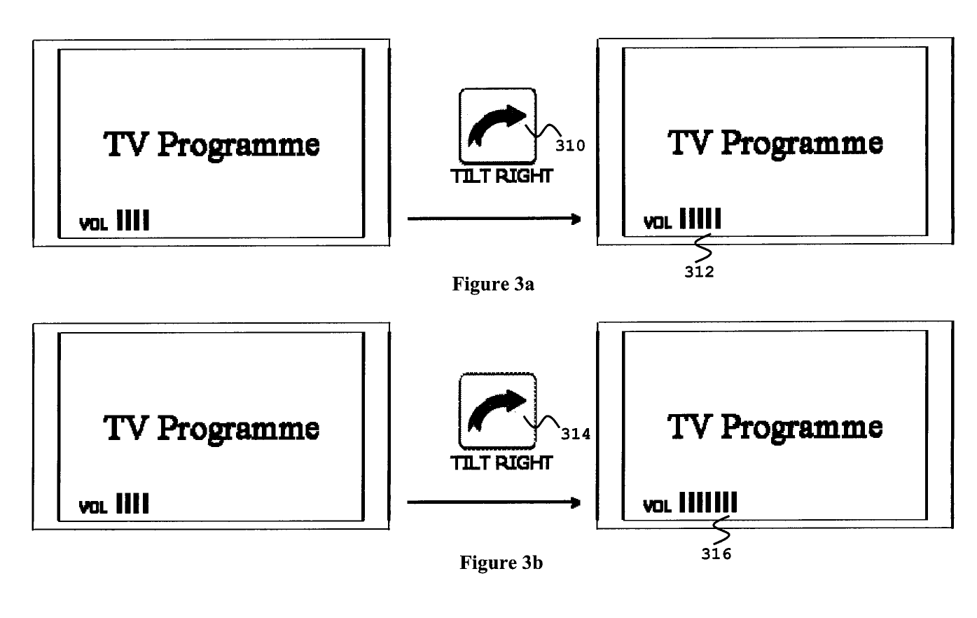

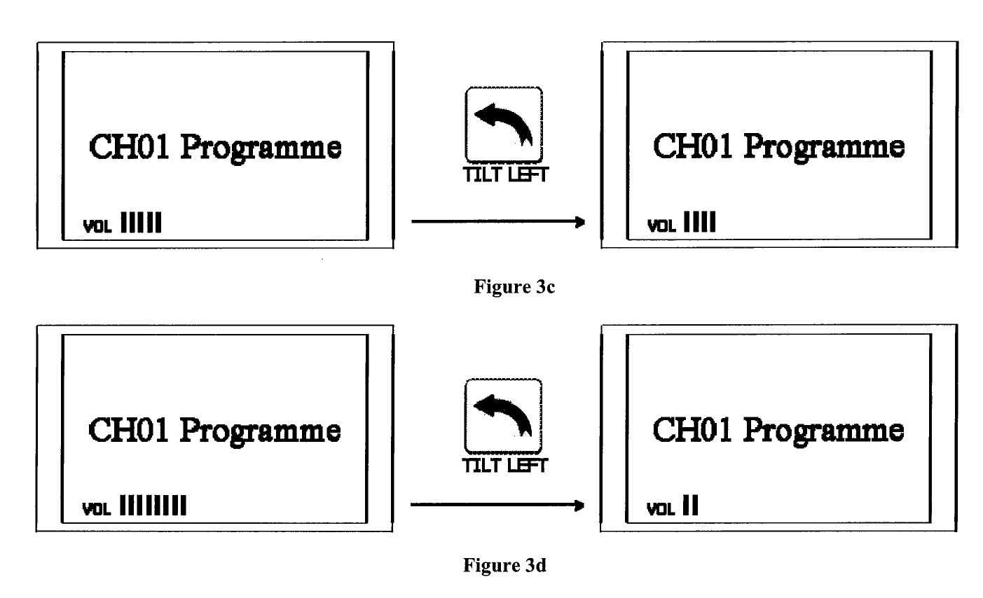

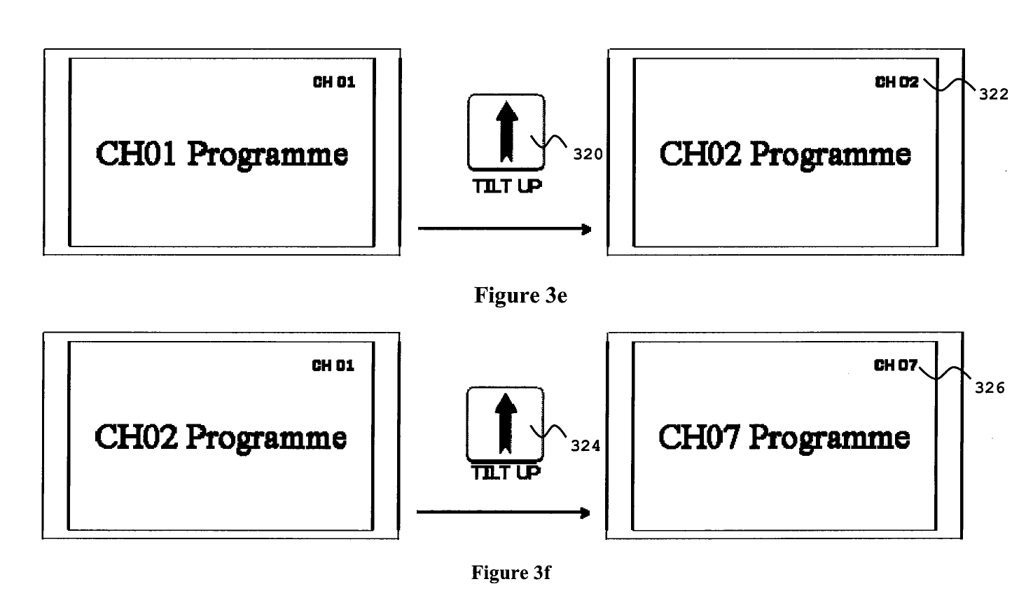

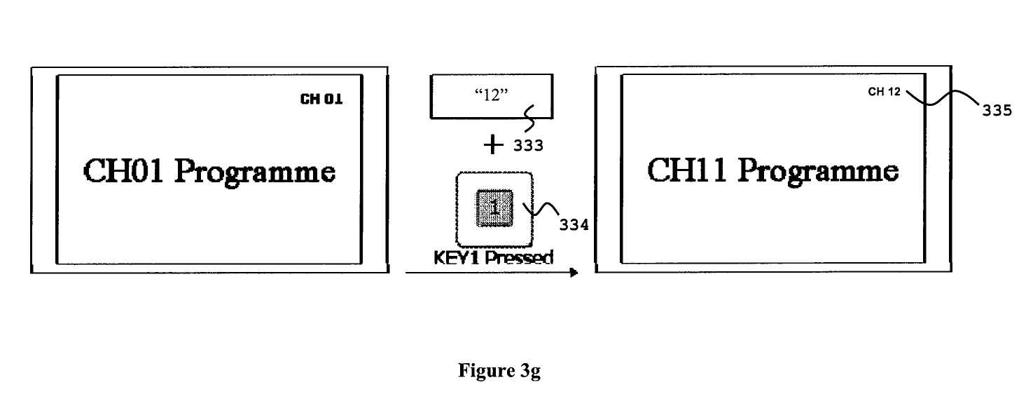

FIGS. 3a-3f illustrate how the motions according to table 2 controls the corresponding functions in TV application. Most of the motions listed in table 2 have the same meaning as those listed in table 1 except that user may define a channel shortcut function by a displacement motion along the x-axis according to the three-dimensional movement in FIG. 2 while chording key “1” on the controller. User may define his/her own hand motion as the meaning of channel shortcut for application in TV. For example, in FIG. 3g, user may write an Arabic number “12” 333 on the plane along the x-axis while chording key “1” 334 on the controller to define a channel shortcut for “channel 12” 335 in the TV application. In TV application, user may also use the hand motion in order to control the volume and sequential channel selection. For example, FIGS. 3a and 3b both illustrate the increase in volume by tilting the controller right when the user is using the TV application. The difference between the motion in FIG. 3a and FIG. 3b is that the user tilts the controller right and return to the original position 310 (FIG. 3a) to increase the volume by +1 per tilting 312 while the user tilts the controller right and holds the controller to the right position 314 until the desired volume 316 is reached (FIG. 3b). FIGS. 3c and 3d illustrate the decrease in volume by tilting the controller to the left for different length of time. The operation is similar to that illustrated in FIGS. 3a and 3b but in a contrary direction. FIGS. 3e and 3f illustrate the sequential channel selection using hand motion of tilting the controller up for different length of time respectively such that the channel is changed by adding +1 channel 322 (FIG. 3e) by tilting of the controller up and then returning to the original position 320 while the channel is kept increasing 326 when the controller is being tilted to the up position for a certain period of time 324 until the controller is returned to the original position (see FIG. 3f).

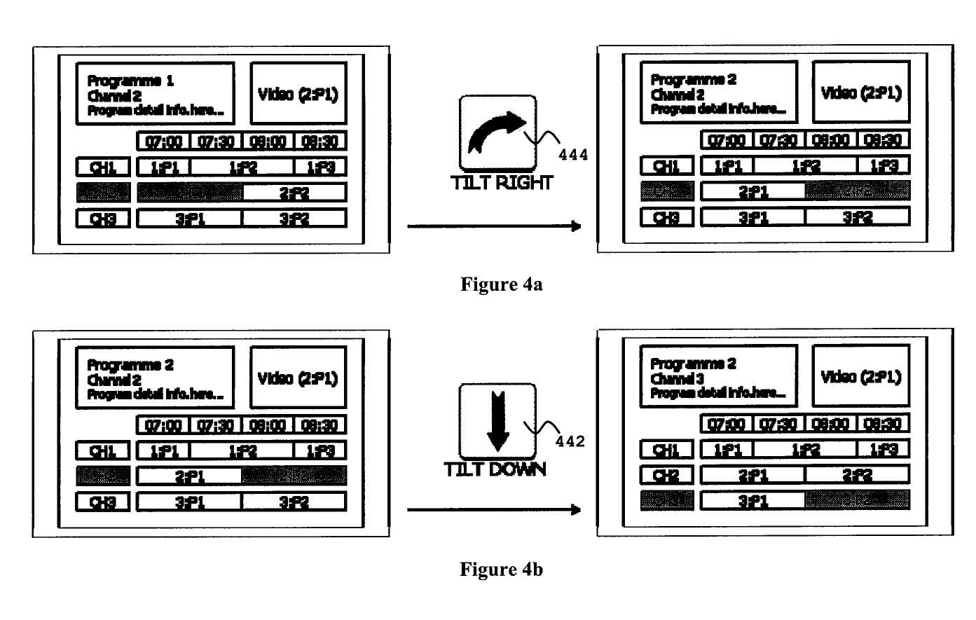

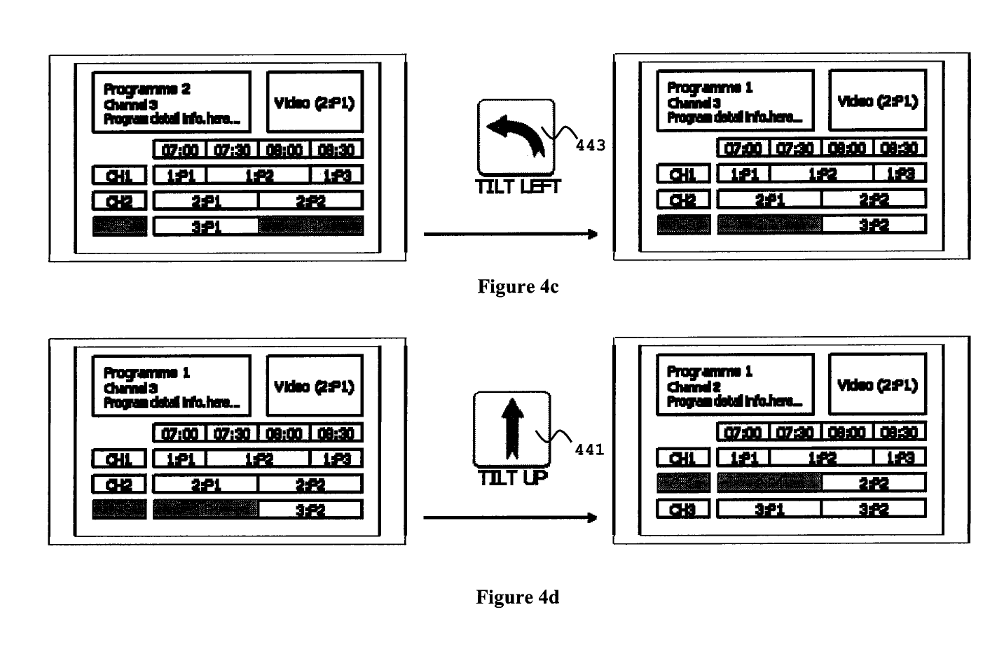

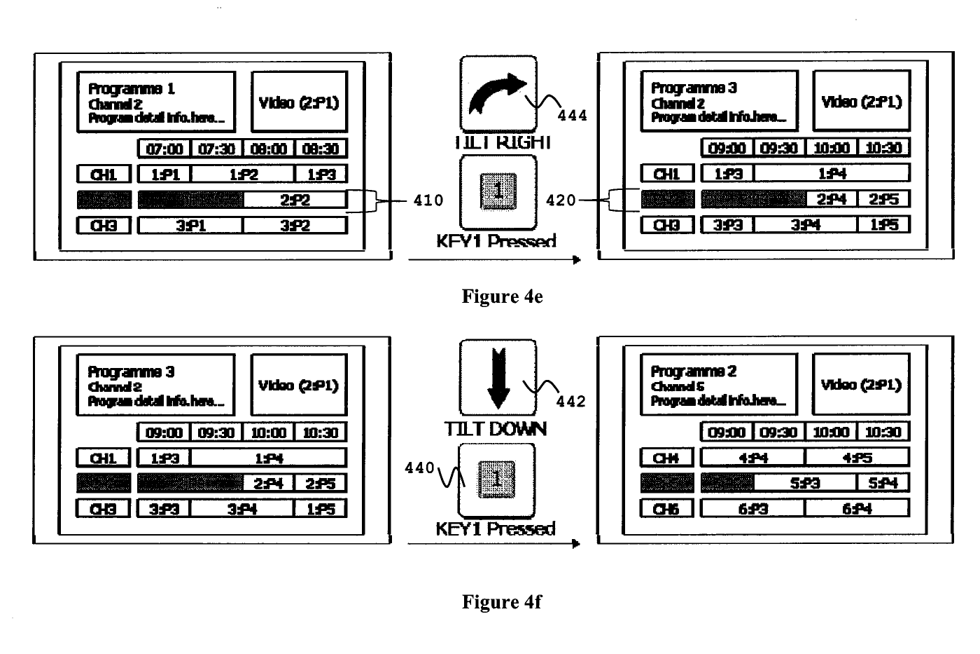

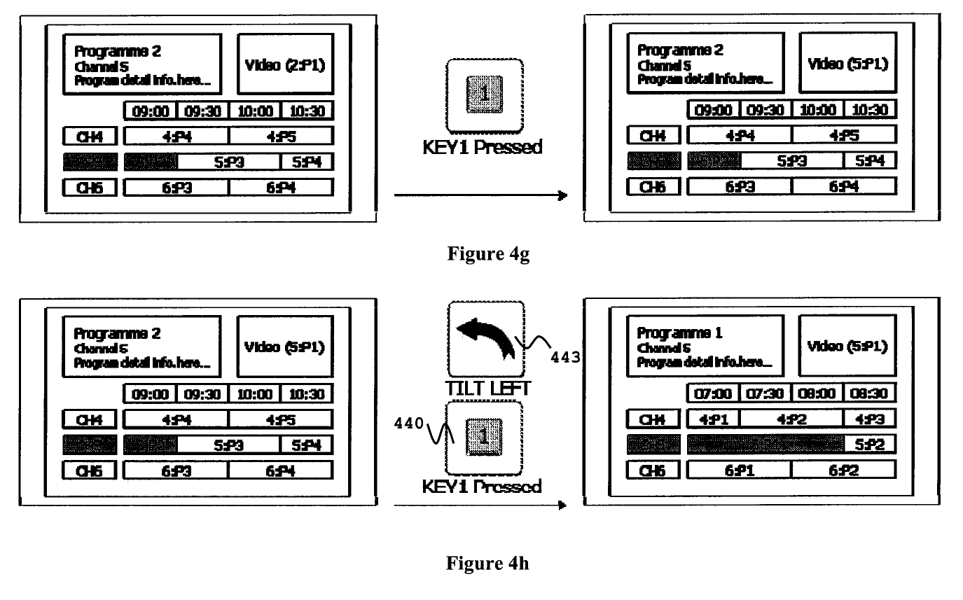

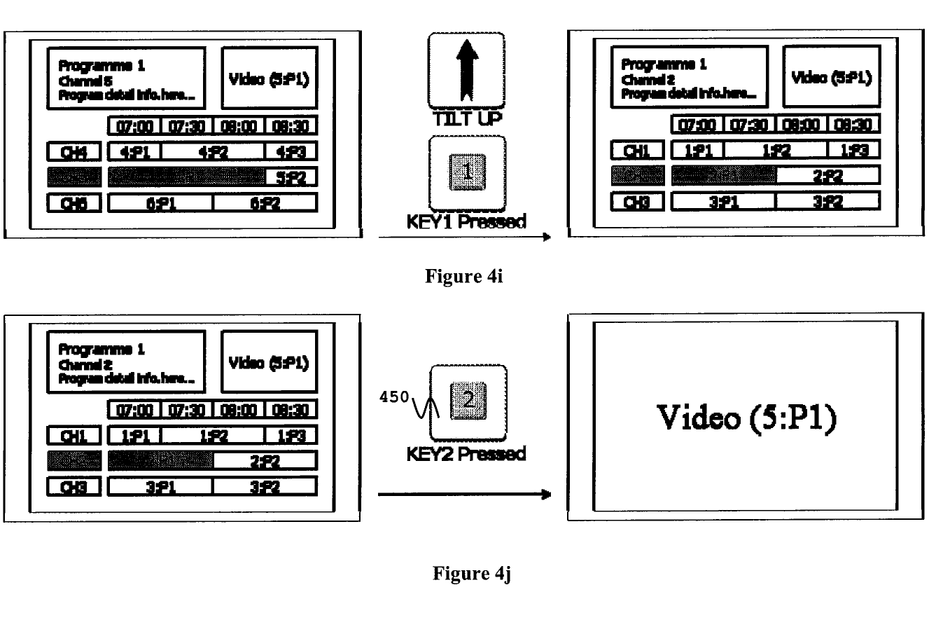

Ten examples using the motions listed in Table 3 to control different functions in EPG application are illustrated in FIGS. 4a-4j.

TABLE 3
Application in Electronic Program Guide (EPG)

| | | | | |
|---|---|---|---|---|
| Motion | Chord/Key “1” | Chord/Key “2” | Meaning | Remark |

| | |
|---|---|
| Tilt Up | Upper item/ |
| | Increase by 1 |
| Tilt Down | Lower item/ |
| | Decrease by 1 |
| Tilt Left | Left item/ |
| | Decrease by 1 |
| Tilt Right | Right item/ |
| | Increase by 1 |
| Key “1” | Select/Enter |
| Key “2” | Back/Exit |

FIGS. 4a-4d illustrate the switching of the cursor to the desired selection box in an electronic program guide (EPG) application displayed on the user interface. User may switch the cursor which is highlighted in gray on the display in FIGS. 4a-4d by using hand motion of tilting up 441 or down 442 position and tilting left 443 or right position 444. In addition to basic directional change, the user may also define the change of selection panel on the EPG according to the illustration in FIGS. 4e-4h. In FIG. 4e, user may tilt the controller to the right 444 while pressing the key “1” 440 on the controller such that the original selection row of CH2 410 is changed to the next row displaying more options for CH2 420. Similar concept is used to change the selection panel in FIGS. 4f and 4h by tilting the controller down 442 and left 443 respectively while pressing the key “1” 440 on the controller. After switching the cursor to the desired selection box, user can press key “2” 450 to confirm the selection of the corresponding selection box, as in FIG. 4j.

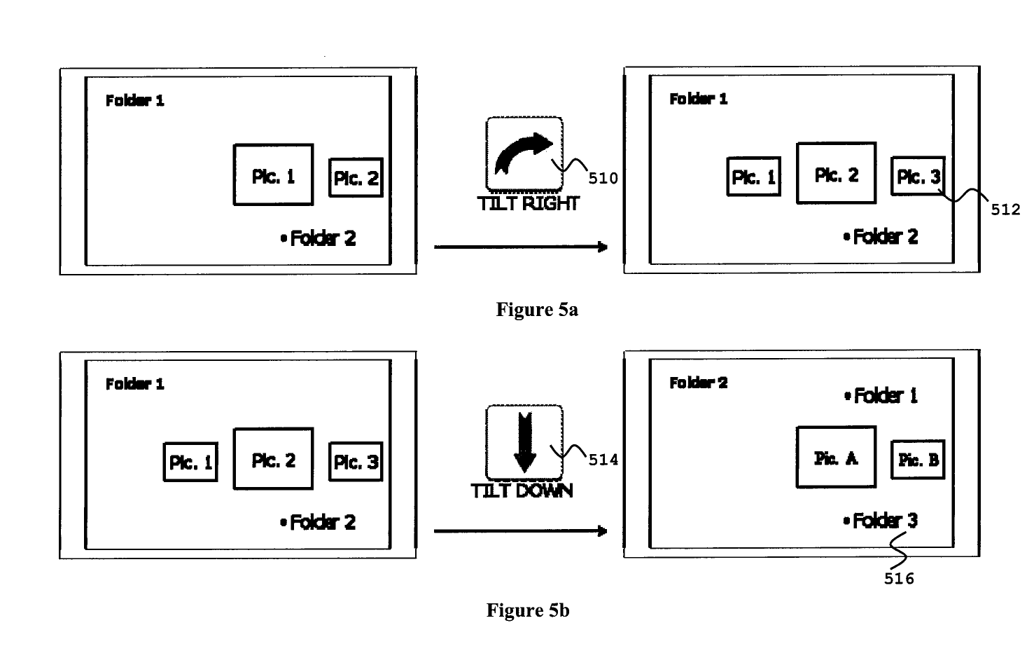

Two examples using the motions listed in Table 4 to control different functions in home media center (HMC) application are illustrated in FIG. 5.

TABLE 4
Application in Home Media Center (HMC)

| Motion | Chord/Key “1” | Chord/Key “2” | Meaning | Remark |
|---|---|---|---|---|
| Tilt Up | | | Upper item | |
| Tilt Down | | | Lower item | |
| Tilt Left | | | Left item | |
| Tilt Right | | | Right item | |
| Key “1” | | | Select/Enter | |
| Key “2” | | | Back/Exit | |

In FIGS. 5a and 5b, the switching of items displayed on the user interface also adopts the general motion setting listed in table 1. FIG. 5a illustrates the switching of the cursor in the same folder in the application of HMC. The user tilts the controller to the right 510 in order to switch the cursor to one item next to the previous one on the right hand side 512. FIG. 5b illustrates the switching of one folder to another folder 516 in the HMC application by tilting the controller down 514.

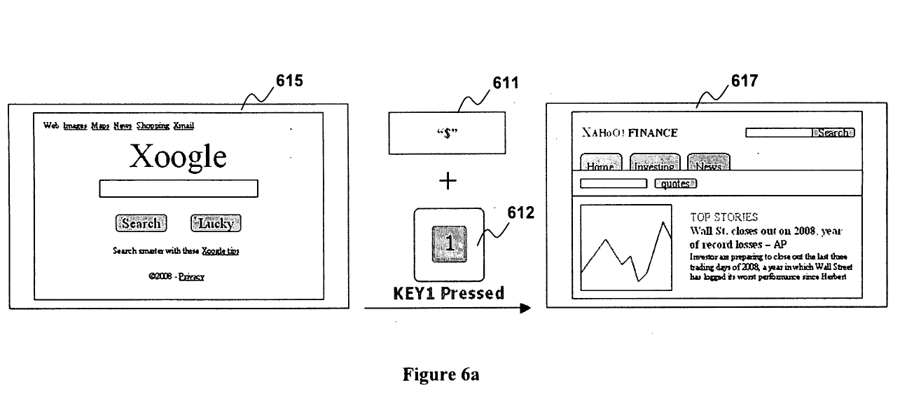

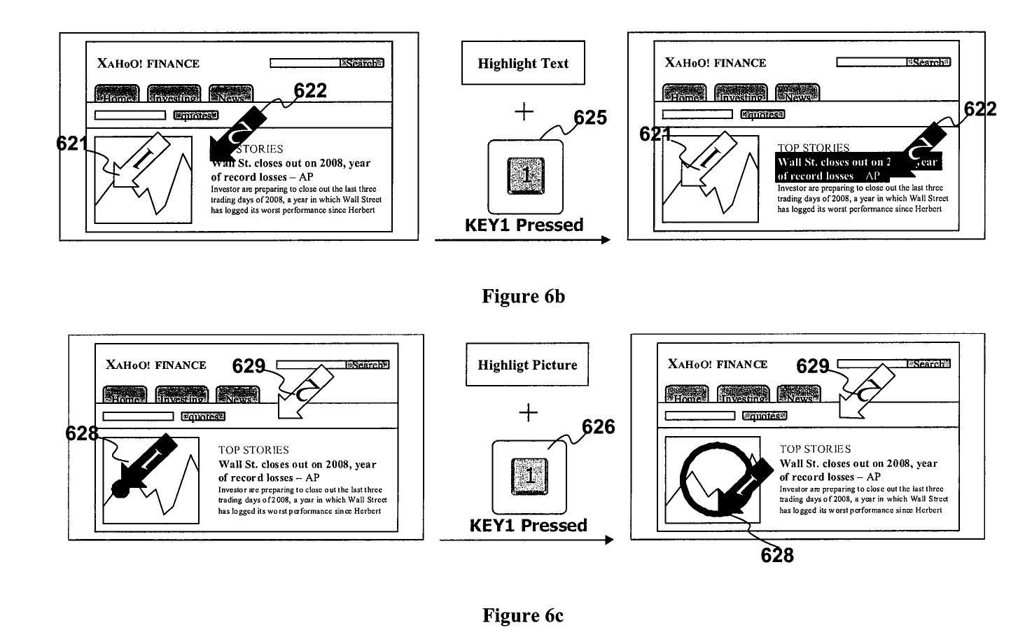

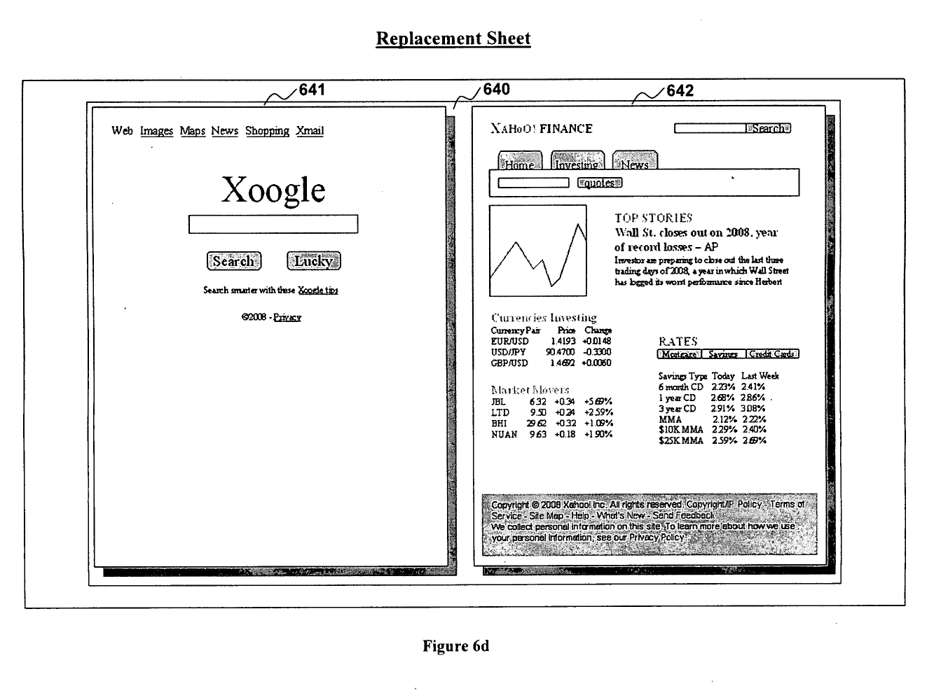

Some examples of using the motions listed in Table 5 to control different functions in Web browsing application are illustrated in FIGS. 6a-6d.

TABLE 5
Application in Web Browsing

| Motion | Chord/Key “1” | Chord/Key “2” | Meaning | Remark |
|---|---|---|---|---|
| Tilt Up | | | Scroll Up | |
| Tilt Down | | | Scroll Down | |
| Tilt Left | | | Scroll Left | |
| Tilt Right | | | Scroll right | |
| Tile −Z | | | Volume Down | |
| Tile +Z | | | Volume Up | |
| Key “1” | | | Select/Enter | |
| Key “2” | | | Back/Exit | |
| Key “2” | | | Menu | Hold for a period |
| Displacement | ✓ | | Motion shortcut | Normal mode: writing ‘$’ |
| Motion + | | | | will go to the financial |
| Chord | | | | website bookmarked |
| Key “1” | | | | |
| Displacement | ✓ | | Highlight the text/picture | Highlight mode |
| Motion + | | | | |
| Chord | | | | |
| Key “1” | | | | |

In FIG. 6a, the user can define a specific handwriting, 611 on a plane of an axis as a motion shortcut of a preference financial website 617 and access this website from any initial website 615. In this example, the user defined “$” as the motion shortcut. When performing such motion shortcut, the user needs to move his/her hand along the path of the “$” sign while chording the key “1” 612 until the completion of such path. The MSI of the system then senses the release of key “1” and maps the corresponding motion event with the motion database, preferably maps such motion event with the bookmarks pre-defined by the user and being stored in the motion database. Through the MIT of the system, corresponding application event is then translated and being sent to application subunits for execution.

FIGS. 6b and 6c show that multiple users can be using the system at the same time. In FIG. 6b, a first user uses a first controller represented by a first cursor 621 while a second user uses a second controller represented by a second cursor 622. The second user can highlight the text by performing a lateral displacement with the second controller while chording key “1” 625. Upon the displacement, the second cursor 622 will move over a text and highlight the same.

In FIG. 6c, the user would like to highlight an image by the claimed invention. A first user uses a first controller represented by a first cursor 628 while a second user uses a second controller represented by a second cursor 629. In this situation, the first user makes a circular displacement with the first controller while chording key “1” 626. Upon the circular displacement, the first cursor 621 will move over an image and highlight the same. Highlighting the image and highlighting the text can be done by different users simultaneously.

In FIG. 6d, the user control one or more applications at the same time or different users control different applications at the same time on the same. In an embodiment, a first application 641 is shown together with a second application 642 in the display 640 simultaneously. User(s) can control different applications at the same time by moving the corresponding cursor over the application he/they desire.

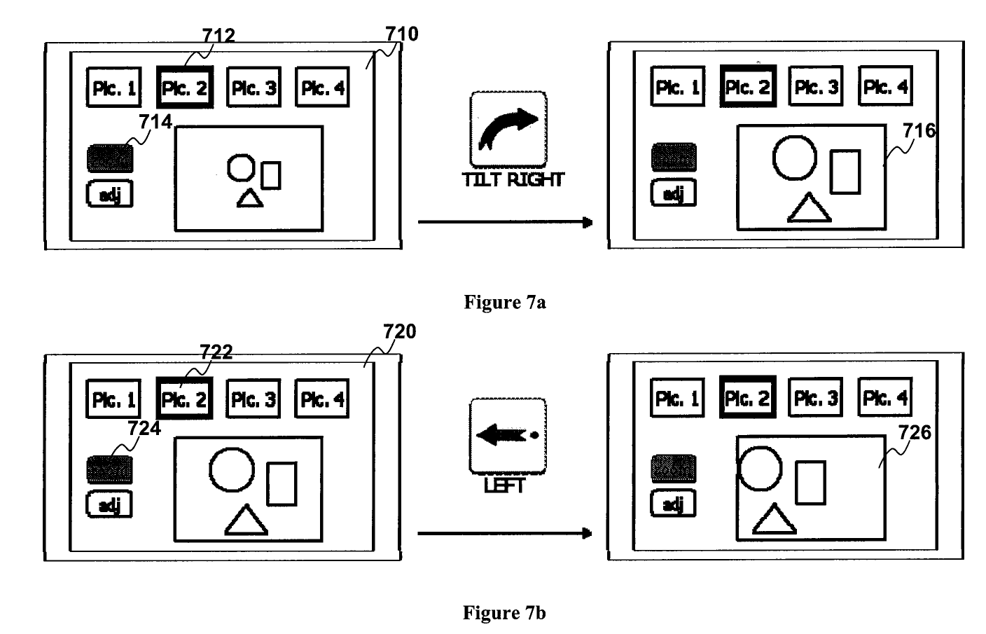

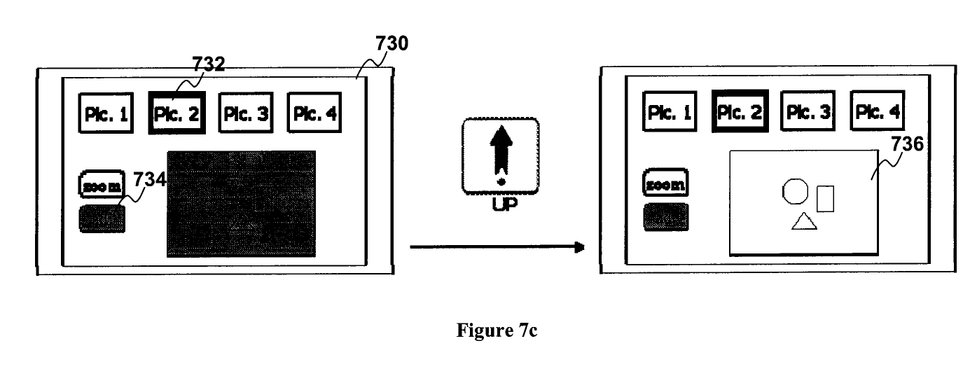

An example of using the motions listed in Table 6 to control different functions in Photo Editing application are illustrated in FIGS. 7a-7c.

TABLE 6
Application in Photo Editing

| | Chord/ | | | |
|---|---|---|---|---|
| Motion | Key “1” | Chord/Key “2” | Meaning | Remark |
| Key “1” | | | Select/Enter | |
| Key “2” | | | Back/Exit | |
| Key “2” | | | Menu | Hold for a |
| | | | | period |
| Tilt Up | ✓ | | Increase brightness | Adjust Mode |
| Tilt Down | ✓ | | Decrease brightness | Adjust Mode |
| Tilt Left | ✓ | | Decrease contrast | |
| Tilt Right | ✓ | | Increase contrast | |
| Up | ✓ | | Pan up | Zoom Mode |
| Down | ✓ | | Pan down | |
| Left | ✓ | | Pan left | |
| Right | ✓ | | Pan right | |
| Tilt Left | ✓ | | Zoom out | |
| Tilt Right | ✓ | | Zoom in | |

In FIG. 7a, a photo editing application is shown on a display 710. One or more pictures can be edited in this application. A picture 712 is selected so that it is displayed in the work area 716. When a zoom mode 714 is selected, the picture 712 is zoomed in by a motion of tilting right.

In FIG. 7b, a photo editing application is shown on a display 720. One or more pictures can be edited in this application. A picture 722 is selected so that it is displayed in the work area 726. When a zoom mode 724 is selected, the picture 722 is panned left by a motion of displacing left.

In FIG. 7c, a photo editing application is shown on a display 730. One or more pictures can be edited in this application. A picture 732 is selected so that it is displayed in the work area 736. When an adjust mode 734 is selected, the brightness of the picture 722 is increased by a motion of tilting up.

While the claimed invention has been described with examples to preferred embodiments, it will be apparent that other changes and modifications could be made by one skilled in the art, without varying from the scope or spirit of the claims appended hereto.

### INDUSTRIAL APPLICABILITY

The claimed invention can be applied in wireless control with a graphical interface for user with physical inability as well as for multiple users with different users' preference of the wireless control.

What we claim:

1. An interactive system comprising a motion sensor detection unit containing one or more three-dimensional controllers; and a motion sensor interface containing a MEMS signal processor, a motion interpreter and translator, an Embedded UI toolkit and an applications subunit.

2. The interactive system according to claim 1, wherein said one or more three-dimensional controllers additionally comprising one or more buttons.

3. The interactive system according to claim 1, wherein said one or more three-dimensional controllers transmit wireless control signals which are selected from the group consisting of ZigBee, Bluetooth Lower Energy, Z-wave and IR.

4. The interactive system according to claim 1, wherein said MEMS signal processor additionally comprises at least one wireless receiver, motion compensator, motion filter and motion database.

5. The interactive system according to claim 1, wherein said at least one wireless receiver receives signals selected from the group consisting of ZigBee, Bluetooth Lower Energy, Z-wave and IR from said one or more three dimensional controllers.

6. The interactive system according to claim 4, wherein said motion database stores signal data received from said wireless receiver and processed by said motion compensator and said motion filter.

7. The interactive system according to claim 4, wherein said motion database matches pre-defined data stored in said motion database with signal data received from said wireless receiver and processed by said motion compensator and said motion filter in order to create a motion event.

8. The interactive system according to claim 1, wherein said motion interpreter and translator translates the motion event from said MEMS sensor processor into a non-browser application event or browser application event.

9. The interactive system according to claim 1, wherein said motion interpreter and translator sends non-browser application event to a non-browser application layer of said applications subunit and receives corresponding motion feedback from said applications subunit.

10. The interactive system according to claim 1, wherein said motion interpreter and translator sends browser application event to a browser application layer of said applications subunit through said Embedded UI Toolkit and receives corresponding motion feedback from said applications subunit through said Embedded UI Toolkit.

11. The interactive system according to claim 1, wherein said motion interpreter and translator sends said corresponding motion feedback to said motion database for storage.

12. The interactive system according to claim 1, wherein said applications subunit execute said non-browser application event and said browser application event based upon the application input.

13. A method of using an interactive system comprising using a controller to create signals based upon the information displayed on a graphical user interface, transmitting said signals virtually from said controller to a receiver, said receiver transmitting said signals to a processor, said processor mapping said signals with a database, translating said motion event into application event after said mapping, executing said application event based upon the result of said translating, and displaying corresponding response on said graphical user interface based upon the result of said executing.

14. The method of using an interactive system according to claim 13, wherein said using said controller additionally comprises capturing motion along x-axis, y-axis, and z-axis about said controller to create said signals.

15. The method of using an interactive system according to claim 13, wherein said using said controller additionally comprises pressing one or more buttons on said controller during said capturing motion along x-axis, y-axis, and z-axis about said controller to create said signals.

16. The method of using an interactive system according to claim 13, wherein said using said controller additionally comprises chording one or more buttons on said controller during said capturing motion along x-axis, y-axis, and z-axis about said controller to create said signals.

17. The method of using an interactive system according to claim 13, wherein said mapping additionally comprises storing said signals in said database.

18. The method of using an interactive system according to claim 13, wherein said translating additionally comprises characterizing said motion event as two types of said application event including browser application event and non-browser application event.
